(19) United States
(12) Patent Application Publication
(10) Pub. No.: US 2014/0108125 A1
(43) Pub. Date: Apr. 17, 2014

(54) SYSTEMS AND/OR METHODS FOR DEFLECTING PRODUCT RETURNS

(71) Applicant: SIRAS.com, Inc., Redmond, WA (US)

(72) Inventors: Maridee J. MARAZ, Redmond, WA (US); Peter J. JUNGER, Redmond, WA (US); Kristin SECRETO, Redmond, WA (US)

(73) Assignee: SIRAS.com, Inc., Redmond, WA (US)

(21) Appl. No.: 14/107,547

(22) Filed: Dec. 16, 2013

Related U.S. Application Data
(63) Continuation-in-part of application No. 13/571,642, filed on Aug. 10, 2012.
(60) Provisional application No. 61/522,966, filed on Aug. 12, 2011.

(51) Int. Cl. G06Q 30/02; G06Q 10/08

(52) U.S. Cl. CPC G06Q 30/0239; G06Q 10/0837
USPC 705/14.39

(57) ABSTRACT

Certain example embodiments relate to techniques that seek to reduce the likelihood of a customer actually returning a product. Information about a product presented in connection a return transaction (and optionally the reason why the product is being presented) is received. A determination whether an award should be generated for the customer in exchange for the customer not returning the product under an applicable return policy is made. The award, with a calculated award amount, is presented for the customer, in exchange for the customer giving up the right to actually return the product under the applicable return policy. The determination that the award should be generated for the customer and the calculation of the award amount each are based on a set of one or more rules that are electronically applicable to at least some of the received information.

### CROSS-REFERENCE TO RELATED APPLICATION

This application is a continuation-in-part of U.S. application Ser. No. 13/571,642, filed on Aug. 10, 2012, which claims the benefit of U.S. Application Ser. No. 61/522,966, filed on Aug. 12, 2011, the entire contents of each of which are hereby incorporated by reference herein.

### INTRODUCTION

Purchased products may be presented for return at retailer or other locations for any number of reasons. A return attempt can be denied, however, because the applicable return period has expired, the product was purchased from a different party (e.g., a cross-retailer), the product was not registered as having been sold in the first place (e.g., suggesting that it was procured fraudulently), etc.

The decision of what to do with a product deemed ineligible for return sometimes is left to the discretion of managers or other suitably authorized individuals. In fact, the assignee has observed that managers at retail locations, etc., recently have started issuing return overrides at increasing rates, thereby forcing products that are determined to be ineligible for return nonetheless to be accepted. An override in this sense occurs because a product that is not eligible for return nonetheless is taken.

Although this approach is a suspected byproduct of the retail or other location trying to maintain or build customer satisfaction, etc., overriding return qualifications unfortunately can erode the profits expected by the retailer and/or manufacturer, as there are costs associated with the returns. These costs may be large and sometimes may be unforeseeable. Indeed, they may not even be fully appreciated by the person authorizing the override. Costs can be triggered by, for example, the in-location processing of the product; the shipping, handling, and inspecting of the returned product, e.g., by the manufacturer, liquidator, and/or other party; the potential shipping, handling, and processing of the product in the event that it is refurbished, remanufactured, and/or otherwise reintroduced into the stream of commerce in the same market or in a secondary market; etc. Even the simple disposal of a product can sometimes carry a cost, in terms of monetary and/or other costs such as environmental impact (e.g., for batteries, tires, electronic devices, etc.).

Of course, most of these costs are incurred, regardless of whether the product actually qualifies for return under an applicable return policy, whether a declined return was overridden, whether the product later is discovered to be a “true defective” product, etc. For instance, a product may need to be shipped to a manufacturer from the return location, tested, repackaged, shipped to an outlet center, etc., regardless of whether it was returned sometime within or outside of a 30-day return window.

Thus, it will be appreciated that it would be desirable to reduce the incidence of returns, regardless of whether the products presented for return transactions do or do not actually qualify for return, e.g., to help curb post-return costs. It also will be appreciated that it would be desirable to provide techniques that help build customer loyalty when an unfavorable experience with a product is encountered, when a product is unwanted, etc.

### BRIEF DESCRIPTION OF THE DRAWINGS

These and other features and advantages will be better and more completely understood by referring to the following detailed of example illustrative non-limiting implementations in conjunction with the drawings, of which:

FIG. 1 is a flowchart showing an illustrative process for offering customer savings merit program rewards, in accordance with certain example embodiments;

FIG. 2 shows an example voucher that may be created in accordance with certain example embodiments;

FIG. 3 is a flowchart showing an illustrative process for implementing voucher redemption, in accordance with certain example embodiments;

FIG. 4 is a schematic view of a system that may be used to implement the customer savings merit program techniques of certain example embodiments;

FIG. 5 is a flowchart showing an illustrative process for attempting to deflect product returns, in accordance with certain example embodiments; and

FIG. 6 is a schematic view of a system that may be used to implement the product return deflecting techniques of certain example embodiments.

### DETAILED DESCRIPTION

Certain example embodiments relate to techniques for facilitating a supplier/retailer driven customer loyalty program that advances customer loyalty by reaching out to consumers with offers that are potentially relevant to the individual shoppers and/or tailored to particular experiences they have had. In certain instances, these techniques may advantageously reduce the likelihood of a product presented for return actually being returned, regardless of whether the product qualifies for return, whether the product might possibly be accepted based on an authorized person's override, etc.

Certain example embodiments may augment an existing loyalty program or reside as a more exclusive standalone program so as to provide the above-described and/or other benefits. In certain example embodiments, customer incentive awards (e.g., vouchers, points, monetary discounts, coupons, etc.) may be provided for specific experiences that customers encounter with a product, brand, retailer store, etc. Conventional loyalty programs sometimes award customers based on sales volume and/or shopping frequency. However, in certain example embodiments, the target of the award may in a broad sense be based on unfavorable experiences and/or customer dissatisfaction. Thus, it may be possible in certain cases to establish or restore a customer's confidence in a product, brand, retailer that has sold the product, etc., and to retain and attract new customers via possibly unanticipated incentive offerings.

### Example Techniques for Identifying and Handling “Negative Experiences”

In certain instances, a program may be implemented in order to help suppliers and retailers identify less than satisfactory customer experiences and proactively respond to exploit the immediate opportunity to turn discontented customers into social retailer/brand advocates. Certain example embodiments provide a link so that a manufacturer and retailer may collaborate to help appease their mutual customers, e.g., in an attempt to restore their brand and reputation. Such situations may come into play, for example, when a customer successfully returns an item to a brick-and-mortar store, e-tailer store, or manufacturer, and the item is determined to be a true-defective or suffer from a manufacturing defect (e.g., after inspection and/or functional testing); when a customer attempts to return an item and the store declines the return; when an item malfunctions and requires a repair; etc.

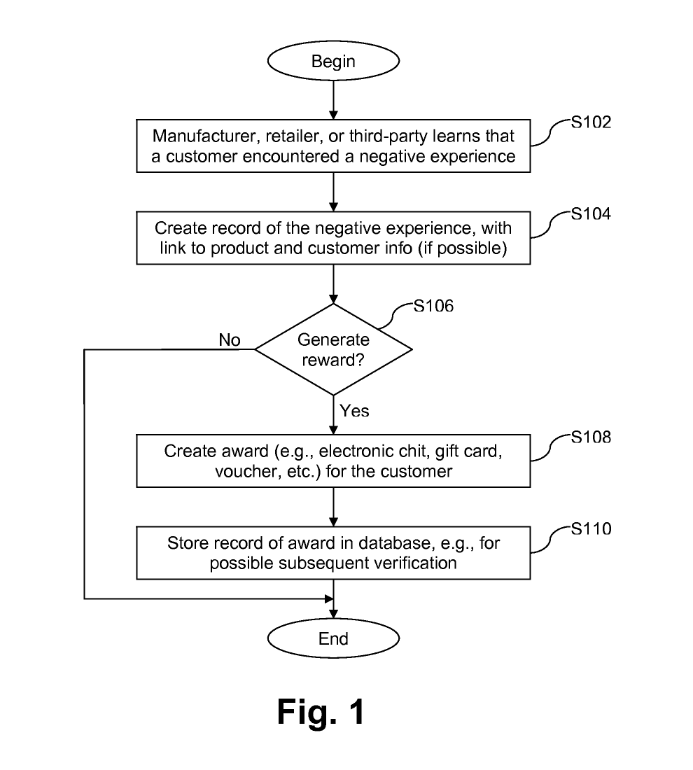

FIG. 1 is a flowchart showing an illustrative process for offering customer savings merit program rewards, in accordance with certain example embodiments. When a manufacturer, retailer, or third-party (e.g., acting on behalf of a manufacture, retailer, or other) learns that a customer encountered one or more negative experiences (step S102), the incident may be posted to a central database. In this regard, a record may be created (step S104), with the record possibly including some or all of: applicable product information (e.g., UPC number, product description, model number, serial number, RFID/EPC number, electronic serial number, etc.), customer name or identifying information (if available) or other information linked to a specific customer, an indication of the negative experience (which may be selected from a predefined list of options or custom specified in some instances), etc. In certain cases, the retailer and/or the manufacturer may not know the consumer identity and therefore may only post the product with its associated unique identifier such as, for example, product serial number, EPC/RFID, or other identifying “license plate” number that the item was tagged with when it was received. The database may include transaction information linking the product's unique identifier with the customer ID. A determination is made as to whether a specific reward should be generated for the customer (step S106), e.g., in accordance with a predefined promotion or other program offered by the retailer, manufacturer, logistics provider, other party, and/or on their behalf/behalves. If so, an award (e.g., an electronic or physical chit, voucher, gift card, etc.) may be created and posted to the account of the customer (step S108). For instance, a voucher associated with an electronic chit or the like may include a barcode or other machine-readable code that embeds at least an electronic pointer to the electronic chit. The award may list at least what the voucher is applicable to, a monetary value, and/or a time limitation (e.g., 1 hour, 1 day, 1 week, 1 month, date range, etc.), and some or all of this data may be printed on the voucher in human readable format and/or embedded in the machine-readable code. A record of the creation of the award is stored in database (step S110), e.g., for possible subsequent verification, validation, and/or other purposes. The record may include, for example, some or all of the above-identified and/or other information.

An approval process or step may be provided in certain instances. A retailer to be made aware of a manufacturer promotion that may apply and, based on such information, the retailer may be able to approve or disapprove of the start or activation of a particular promotion. Of course, in certain instances, the inverse may also apply, and a retailer may run a promotion that the manufacturer can approve or disapprove. In still other cases, the retailer, manufacturer, and/or other parties may all run promotions that the other parties may or may not elect to participate in. This approval process or step may be performed as a part of the step S106 determination shown in and described in connection with FIG. 1, or before or after it, in different example embodiments.

In certain cases, a promotion may be initiated automatically, e.g., once a certain number of complaints of a certain type and/or for a certain product are received. For instance, once complaints are posted for a threshold number or percentage of products, a promotion may be automatically triggered and thus become active. The database may classify the complaints into defined categories to facilitate this sort of tracking. A plurality of policies may be predefined and may be initiated automatically, e.g., at different levels or numbers of complaints in certain instances. In other instances, promotions may be started manually. In either case, an interface to the database over a network may be provided so that the relevant parties can define some or all of the parameters of the promotions, start/stop promotions, etc.

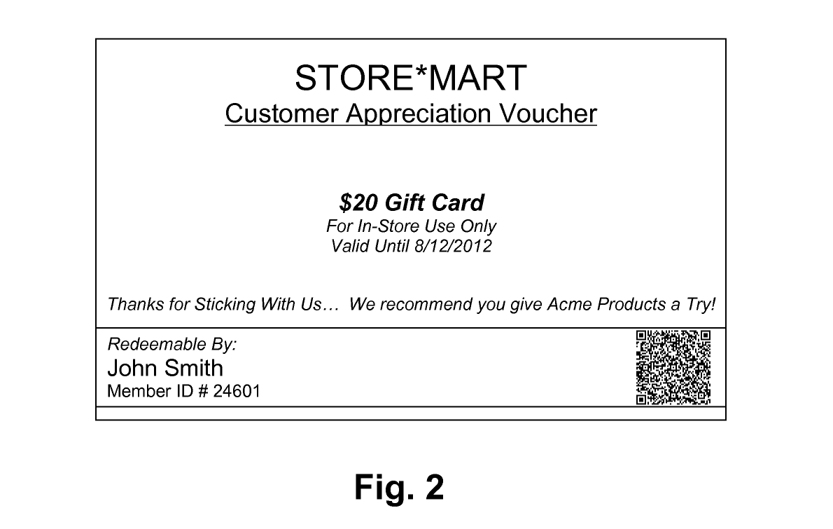

When a certain condition is met, a voucher may be generated and issued to customers who qualify for it. An example voucher is shown in FIG. 2. The voucher may be in an electronic or printed form, and may have indicia of its value (e.g., in terms of dollars of other currency, points, etc.). The awards may be made available for redemption immediately, at a later date/time, contingent on other purchases, etc. A post may be made to the database to reflect the voucher's proper awards value (whether that be expressed in points, amount of discount, coupons, etc.) so that rewards can be tracked and so that the likelihood of potential fraud associated therewith (e.g., from copying, false claims, multiple uses, etc.) may be reduced (e.g., as noted above in connection with step S110 in FIG. 1). The vouchers that are issued may each have their own unique identifiers in certain example embodiments.

The amount of the award may be based on the manufacturer posted or contractual predetermined dollar amount and/or the specific experience the customer encountered. For instance, a formula may be defined in accordance with a contractual agreement. The formula may involve a weighted combination of terms such as, for example, number of times a (or the) problem happened for a customer, the severity of the problem(s), the amount the product cost, etc. These factors may have linear or non-linear weights assigned to them. For instance, a customer who has encountered a number of problems may have an increasing weight. On the other hand, if it appears that the customer is abusing the program (e.g., by making a number of claims that are suspect in terms of type, quantity, value, etc.), the rewards may then be reduced or excluded. In certain example embodiments, a negative quadratic value may be applied so as to help protect against this situation, with the maximum point of the quadratic graph being at a predetermined threshold value (in terms of dollar amount, number of problems, etc.). The voucher may include consumer- and/or problem-specific messages. For instance, if a consumer (or multiple consumers) had an issue with Brand X, the program may recognize this and suggest an alternate brand, etc.

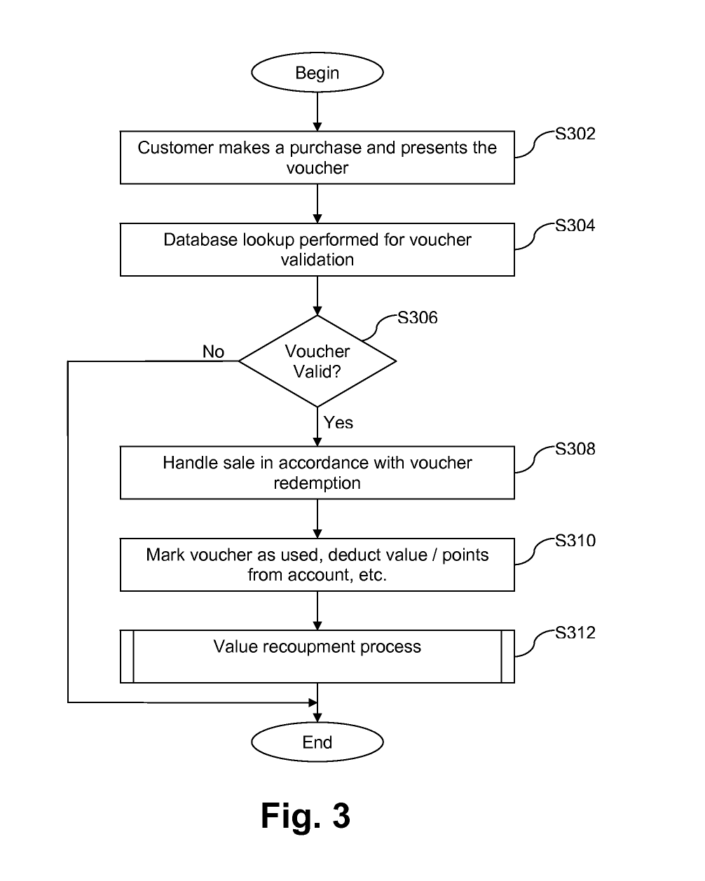

FIG. 3 is a flowchart showing an illustrative process for implementing voucher redemption, in accordance with certain example embodiments. In terms of voucher redemption, the customer may make a purchase and present the voucher (e.g., in person or through a suitable user interface area in an online purchasing system) in step S302. In some cases, the register may initiate a prompt for “voucher available” and/or “voucher value” (e.g., at the end of the transaction). In other instances, a voucher identifier may be scanned (e.g., as if it were a coupon or the like). In other words, purchased items may be scanned along with the voucher presented by the customer in other cases. A lookup to the database (e.g., by a point-of-sale system or register, online purchasing system, etc.) may be initiated to validate the voucher in step S304. This lookup process may be facilitated using the unique identifiers associated with the vouchers. The validation process may include, for example, determining whether the voucher is active, whether eligibility conditions have been met (e.g., if it can only be used at a certain store, to buy or replace a particular product, within a certain time window, etc.), how much value is to be conveyed, etc. If all conditions are met (e.g., as determined in step S306), voucher value may be applied and deducted from the customer's total amount, or another suitable action may be taken, in step S308. In step S310, the voucher may be marked as used, its value or a corresponding number of points may be deducted from the customer's account, etc.

In certain example embodiments, the customer may be asked to present identification (e.g., a driver's license or program-specific card) to access the earned points or value. In other cases, credit or debit cards may provide a suitable verification and link, and for privacy reasons, related information may be hashed and the corresponding output stored in a database.

After the voucher is redeemed, an invoice may be generated to recoup the value of the voucher from the manufacturer (or a specific retailer department, if the voucher was issued by the retailer) in step S312. The third party managing the database may facilitate the voucher reconciliation and/or generating the invoice, potentially for a fee. For instance, a third party may take a percentage of the sale (e.g., 1%, 2%, etc.) or a fixed agree-to amount. In different embodiments, billing between the retailer and supplier/manufacturer may be direct, a deduction from an invoice (e.g., a charge-back), or through an intermediary such as the third party. This recoupment process may be transparent to the consumer in some instances.

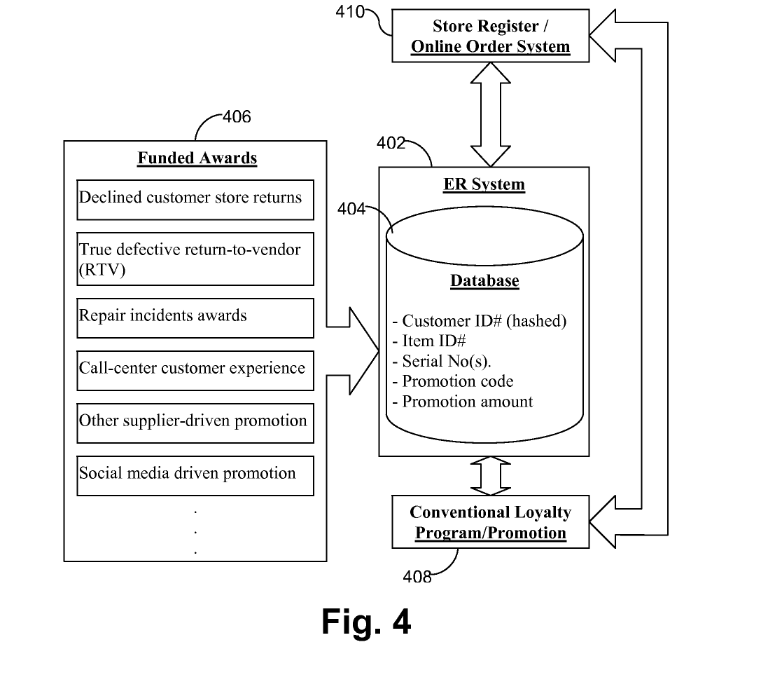

The FIG. 4 diagram provides an overview of an illustrative system in accordance with certain example embodiments. It is noted that the ER system 402 described in greater detail below may include one or more processors and a non-transitory computer readable storage medium tangibly storing the ER database 404. In certain instances, the ER database 404 may be multiple databases, multiple tables within one or more databases, etc. The funded awards 406 may be manufacturer or retailer funded, or shared cost awards. The funded awards 406 may have definitional information associated therewith including program eligibility requirements such as, for example, criteria concerning certain classes of consumers who can access the program (registered users only, all consumers, consumers who have bought a particular product or brand within a certain timeframe, etc.), specific problems that the program is directed to resolve or address, specific places and/or parties that may trigger the program (e.g., certain preferred retailers, distributers, manufacturers), etc. Additional definitional information such as, for example, what the award/reward is, when/how it can be redeemed or used, what it can be redeemed on, etc., also may be specified. Criteria for calculating award/reward amounts also may be specified, as may an overall “pot” devoted for a particular program (e.g., such that the program is discontinued after its “pot” has been used up), etc. Flags may be stored to indicate whether relevant business partners have approved a particular program (e.g., a retailer may seek manufacturer approval for a particular program, and vice versa). The conventional loyalty programs/promotions 408 similarly may be manufacturer or retailer funded, or shared cost programs/promotions. These and/or other awards may be defined via respective user interfaces accessible by authorized users via suitable configured computers. Furthermore, multiple more conventional loyalty programs/promotions may be provided, which may or may not be in communication with the ER system 402 and/or the funded awards system as a whole.

As alluded to above, interfaces may be provided to authorized parties (manufacturers, retailers, etc.), so as to help define the parameters of the various awards and/or programs. These interfaces may provide restricted access to the data in the ER database 404. For instance, manufacturers and retailers may be blocked from seeing customer information, or information about other competitor manufacturers or retailers. Manufacturers may have access to retailer information only if they are designated partners in certain cases, and vice versa. It will be appreciated that the funded awards shown in FIG. 4 are provided by way of example. The interfaces may be accessible over a network, e.g., via a computer. In certain cases, a client computer may connect to one or more server computer(s) administering the funded awards 406 and/or conventional loyalty program/promotions. The interfaces may be used to provide the definitional and/or other information relevant to a particular program. A store register, online order system, or the like 410 may have access to the ER system 402, the conventional programs 408, etc., which may be useful in known ER techniques, as well as in the administration/management of, and/or cooperation with, the example funded award program techniques described herein.

There are a number of possible situations that might trigger the generation of a voucher and/or cause an entry in the database system for possible consideration as to whether to count the “bad experience” towards generation of a future voucher. These situations may include, for example:
1. True defective return-to-vendor (RTV)
2. Declined customer store returns
3. Repair incidents
4. When an item (product) is returned due to a manufacture defect recall
5. Call-center customer experience (manufacture, retailer, or third party)
6. Social media driven promotion
7. Supplier driven promotions
8. Retailer driven promotion
   Each of these example situations is discussed in greater detail below.

1. True Defective Return-to-Vendor (RTV): Accepting customer returns is a standard practice with retailers in the U.S., Canada, and certain other parts of the world. The reason behind these returns vary from consumer remorse, dissatisfaction, ease-of use, obsolescence, price erosion, fraud, true defective products, etc. Although some customer returns are justified (possibly about 10% to 30%), many of them are not. Because retailers find it difficult to substantiate it one way or the other, and in an effort to retain customers, retailers tend to be kindhearted and not squabble with their customers at great expense to the retailer and manufacturer. For those products ultimately returned to the manufacturer (RTV) and proven to be defective as determined through functional tests by the supplier or designated third party, consumers have been negatively impacted and inconvenienced. This leads to a tarnished reputation to the brand and to the retailer that sold the product to the customer. Salvaging and restoring the customer's confidence in the brand and the retailer would be desirable in such situations. Certain example embodiments may thus help enable a manufacturer (and/or retailer) to accommodate the customer, potentially in a manner that helps restore credibility and/or reputation.

The supplier may submit the product's unique identifier (that has proven defective) to a database where the customer's award points or monetary value are posted to a customer account or associated with a identifier so that they are available for redemption at a later time (e.g., at the retailer, an e-tailer, for purchase of a similar product elsewhere, etc.). An appreciation email could also be sent to the customer on behalf of the supplier and/or retailer, thanking the customer for the continued support of the brand/retailer. The points/value updates may also be reflected on a future or next purchase and printed on the receipt.

2. Declined Customer Store/On-Line Returns: Many products returned to a retailer are found to be non-defective and are returned for other reasons. Some top reasons include: buyer's remorse, product obsolescence, a need for cash (or in-store credit), fraud, etc. It has been found that only a very small percentage of these returns actually require repair. When a product return is declined by a retailer, it could be advantageous to the retailer and the supplier (vendor/manufacturer) to accommodate the customer in some way. For instance, if a customer wants to return a game console device but is declined because it was purchased more than six months ago, it would be advantageous for the manufacturer to offer a note of gratitude (points/value) to the customer for keeping the game console and to encourage future product purchases from that manufacturer, such as new game software. This approach may reduce the number of store manager overrides related to customer discontent and save the manufacturer and the retailer millions of dollars annually. Certain example embodiments thus may provide awards to help ensure that the number or percentage of overrides for a given timeframe falls within a predefined threshold. For instance, some embodiments may offer awards in amounts targeted at ensuring that overrides stay below 50% of declined return transactions, below 33% of declined return transactions, below 25% of declined return transactions, or some other value, over a given timeframe (such as, for example, a week, month, quarter, fiscal year, etc.).

The retailer (through an ER service, for example) may forward the serial number or other unique identifier of a product to the database where a return attempt was made and the retailer declined it. The same techniques as in (1) above could be used. For instance, the database could post the customer's award points/value to the customer's account and makes them available for redemption at the retailer. An appreciation email could also be sent to the customer on behalf of the suppliers and retailer, thanking the customer for the continued support of the retailer and brand. The points/value updates would also be reflected on their next purchase and printed on their receipt.

3. Repair Incidents: When a product is indeed in need of repair, a customer is inconvenienced and endures benefit denial while the product is out being repaired. The reputation of a brand can be severely damaged by the way a company handles the interaction with the customer. For these reasons, a manufacturer may consider offering a note of gratitude (points/value) to their customer so as to help possibly regain a customer's confidence in the brand.

The supplier may forward to the database the product's unique identifier that has undergone repair by the supplier or their third-party Authorized Service Centers (ASC). The database may post the customer's award points/value on the customer's account and make them available for redemption at the retailer. As above, an appreciation email could also be sent to the customer on behalf of the supplier and retailer, thanking the customer for the continued support of the brand/retailer. The points/value updates could also be reflected on their next purchase and printed on their receipt.

4. When an item (product) is returned due to a manufacturer defect recall: See (1) above.

5. Call-Center Customer Experience: Companies (manufacturers and/or retailers) use Inbound Call Centers to assist customers with problems that range from technical problems to user questions to sales of accessories and peripherals. Strategic initiatives that award the customer for their perseverance in getting a resolution to their problem can improve the customer experience, enhance the relationship with the company, and set it apart from its competitors. In today's competitive marketplace, superior customer service is quickly becoming a brand differentiator.

The supplier's call center may forward to the database customer account information and/or the serial number (unique identifier) of the product. Similar to the above, the database may then post the customer's award points/value to the customer's account and make them available for redemption at the retailer. An appreciation email could also be sent to the customer on behalf of the supplier and retailer, thanking the customer for the continued support of the brand/retailer. The points/value updates could also be reflected on their next purchase and printed on their receipt.

6. Social Media Driven Promotions: A manufacturer/supplier could use a utility to reward current and/or new customers for social media leads (e.g., via Facebook, Twitter, LinkedIn, etc.), and/or for encouraging people to further promote their brand and/or a retailer. For instance, it may be possible to track “likes,” hash tags, recommendations, the social media equivalent of “word-of-mouth” or buzz, etc.

7. Supplier Driven Sales Promotions: Such promotions could take place during, for example, product launch (potentially offering complimentary specials or bundles on the fly); end-of-life product clearance specials; preemptive counter competitor specials; product recalls customer satisfaction award (e.g., for specific serial numbers or serial number ranges, batches, pallets, etc.), and/or the like.

The supplier may forward to the database customer account information and/or the serial number of products, along with the promotion type. Similar to the above, the database may post the customer's award points/value on the customer's account and make them available for redemption at the retailer. An appreciation email could also be sent to the customer on behalf of the supplier and retailer, thanking the customer for the continued support of the brand/retailer. The points/value updates could also be reflected on their next purchase and printed on their receipt.

These types of award promotions could be configurable by the offering party, and certain awards may be preapproved by the retailer. Others may require additional approval by the retailer and may be flagged via exception alerts and forwarded to the appropriate retailer contact, e.g., the buyer.

8. Retailer Driven Promotions: Certain example embodiments may enable suppliers to link up with their retailer partners' systems to promote customer loyalty through individualized offerings. A black-box or more open approach may be provided, through which suppliers can partner with their retailers in delivering various rewards/promotions to their mutual customers.

The example transmissions described above may be made individually and/or in batch in different example embodiments.

The following table includes a number of benefits and/or highlights for customers, retailers, and suppliers that may accompany the programs of certain example embodiments.

| CUSTOMER | RETAILER | SUPPLIER |
|---|---|---|
| Additional savings | Know your customer | Improve brand loyalty |
| Additional perks | Retain customers | Improve customer |
| | | satisfaction |
| Additional buying | Attract new customers | Incremental sales |
| dollars | | |
| Greater product/ | Promote greater | Fewer returns |
| brand experience | spending | |
| Improve shopping | Improve customer | Data intelligence |
| experience | satisfaction | |
| Greater loyalty with | Improve sales and profit | Introduce customers to |
| retailer | | same brand new product |
| | | categories |
| | Lower prices for your | Precise warranty data |
| | customer | |
| | Increase net sales | Call center intelligence - |
| | | reduce talk-time and |
| | | improve customer |
| | | satisfaction |
| | Addresses manager | Turn unhappy customers |
| | Overrides | into social brand |
| | | advocates |
| | Identify and reduce | |
| | fraud | |
| | Unique services by | |
| | customer-class or | |
| | individual customer | |
| | Data intelligence | |
| | Increase shopping basket | |
| | Boost shopping | |
| | frequency | |
| | Improve store navigation | |
| | and customer awareness | |
| | of other store categories | |
| | Turn unhappy customers | |
| | into social retailer | |
| | advocates | |

Internet sales that are returned to brick-and-mortar stores may be linked via serial number or other unique identifier in certain instances, and a voucher from the proper party may be thus issued.

As alluded to above, a customer may have to enroll in the program and may obtain a program-specific account that can accumulate points or rewards. The ER system shown in and described in connection with FIG. 4 may, for example, maintain registration information, in certain example embodiments. In certain other example embodiments, the party or parties offering the promotion may maintain such registration information, and the ER system optionally may have access to some or all of this information (which may be needed in the issuance and/or validation of a particular award/reward). The rewards or points balance may be reflected on the receipts of qualifying purchases and/or when the customer is identified. Thus, retailers and/or manufacturers may proactively contact registered users in the event that a recall is necessary, that a large number of products have a known defect or problem, that a return/warranty request will likely be necessary, etc. In certain implementations, a customer may determine whether points are to be stored or used automatically at a next sale. In certain implementations, a retailer/manufacturer may determine whether points or rewards are tied to sales or percentages returned.

### Example Techniques for Deflecting Attempted Product Returns

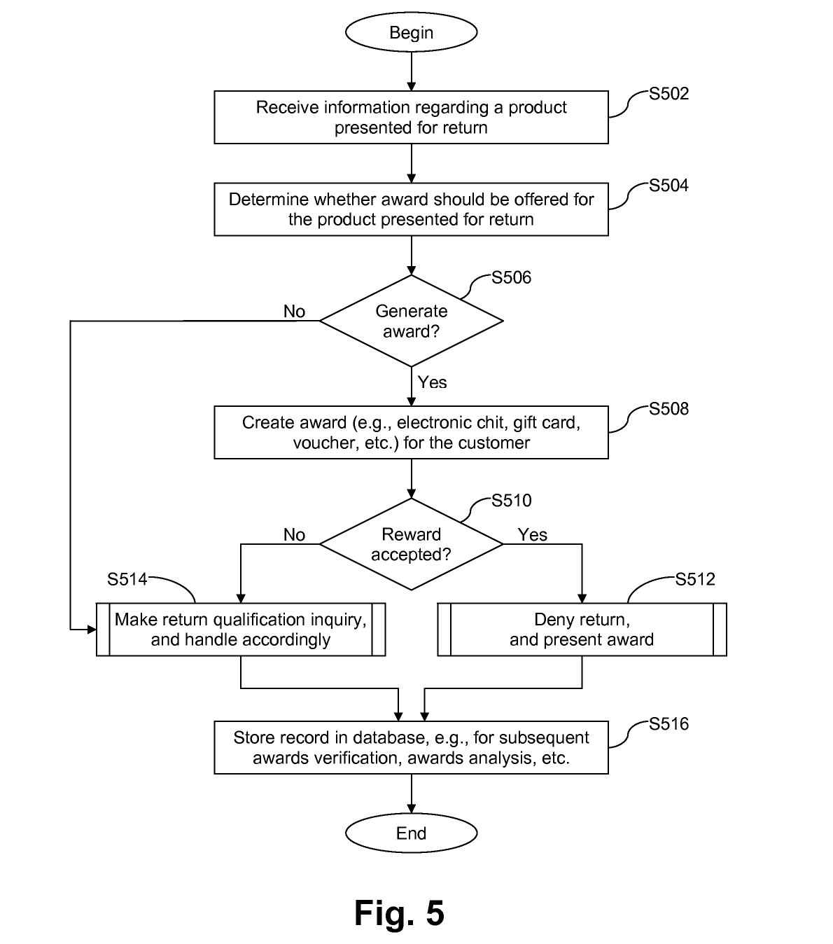

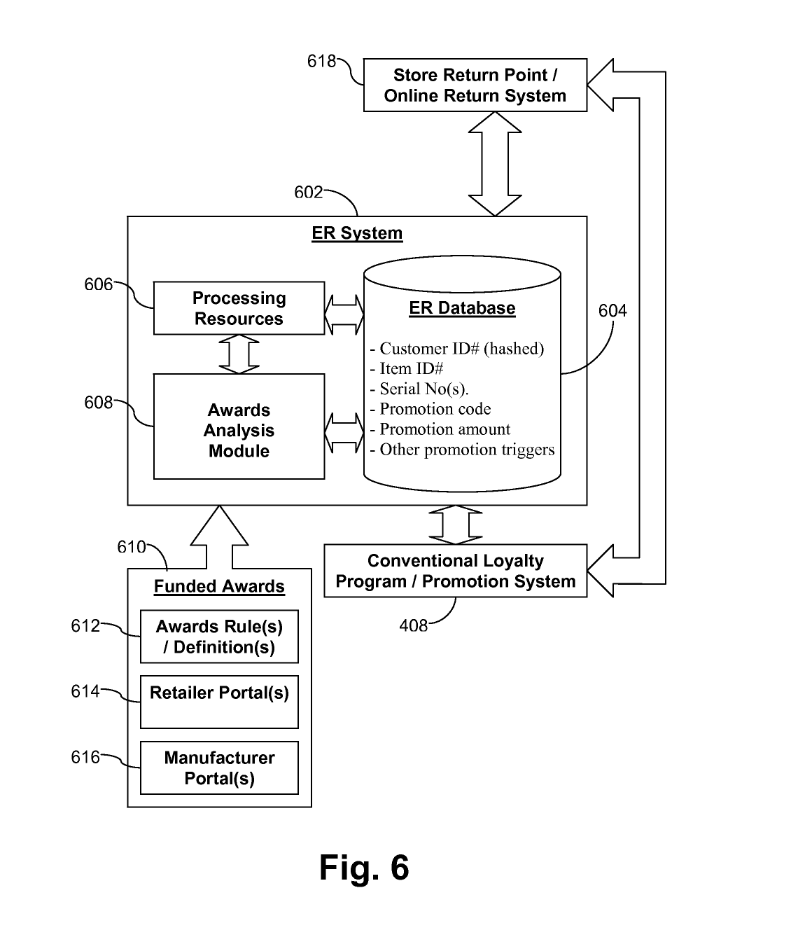

The techniques described above may be applied after a product has been accepted for a return. However, certain example embodiments relate to techniques that offer monetary and/or other incentives to encourage customers to keep products that are presented for return, regardless of whether they qualify for return using applicable return policies. In this sense, certain example embodiments help preempt or deflect returns, e.g., as will be described in greater detail in connection with FIGS. 5-6. It will be appreciated that the approaches taken by certain example embodiments may be used in connection with a variety of scenarios that are unrelated to whether a product actually qualifies for return under an applicable return policy, whether a store manager or other authorized person likely would issue a return override for a non-qualifying product, etc. For instance, as explained in greater detail below, vouchers or other forms of value may be generated for customers who present purchased products for return, e.g., in an attempt to help persuade those customers to keep their products (even though they might actually qualify for return)—but generated vouchers or other forms of value will not be given to customers who nonetheless return their products.

FIG. 5 is a flowchart showing an illustrative process for attempting to deflect product returns, in accordance with some embodiments. As shown in FIG. 5, in step S502, information is received regarding a product presented for return by or on behalf of a customer. The information may be received from a retailer location, an e-tailer, a call center, or other physical or virtual location, e.g., through an online return authorization system that operates over a computer network such as a LAN, WAN, the Internet, or the like. A computer, mobile device (such as a smart phone, tablet, etc.), or other suitable electronic device may be used to deliver the information. The information that is received may include a unique identifier of the product such as, for example, a serial number/UPC combination (e.g., received through a barcode scanner, QR code scanner, or the like), an EPC code (e.g., received through an RFID reader or the like); an indication of why the product is being presented for return (e.g., as selected from a menu of predefined options, as custom-entered via a keyboard or the like, etc.), an indication of whether the customer is a member of a loyalty program or other promotional system (e.g., as determined in connection with a member identifier or the like), etc. It will be appreciated that non-unique identifiers may be entered, as well, in which case information for the same or similar product may be used to make one or more inferences about the product presented for return. See, for example, U.S. Pat. No. 7,729,923, the entire contents of which are hereby incorporated by reference herein. For instance, it may in some cases be possible to scan or otherwise acquire a non-unique identifier of a particular item (e.g., a UPC) and use that non-unique identifier to gain at least some information about the item, e.g., at a general product level. General information may include, for example, a general profit margin for the product, a weight of the specific item, etc. It thus will be appreciated that it may in some instances may be factor into the calculation of an award amount approximate, expected, and/or sometimes even actual costs for return processing, etc., even for non-uniquely identified products.

There are many possible reasons why a product could be presented for return, and some negative experiences are identified and discussed above. Of course, it will be appreciated that the factors identified above are not exclusive. For instance, buyer's remorse, price drops or price adjustments from the same vendor, rebates becoming available from the manufacturer or some other party, sales being run by other vendors, promotions being run by the same or a different vendor, new product launches, etc., are some example reasons why a customer might want to return a product, regardless of whether a possible return attempt is inside or outside of a acceptable return window.

In any event, once some or all of this information is received, a determination is made in step S504 as to whether an award should be offered for the product presented for return, e.g., in order to try to deflect the product return. In certain example embodiments, this determination may be made by having the ER system look up a record associated with the product presented for return. For instance, the ER system may consult the ER database to determine whether the uniquely identified item has been specifically flagged as being eligible or ineligible for a possible award. As another example, the ER system may consult the ER database to determine whether there is a specific eligibility/ineligibility indication on a product-wide basis (e.g., determined via a UPC or other non-unique identifier lookup). As still another example, a lookup may be performed in connection with the loyalty program/promotional system in order to determine, for example, whether the particular person presenting the product for return has been deemed to be entitled to “special treatment,” e.g., indicating that an award should be generated (for instance, in the case that the person is a first-time customer and thus likely to form a first impression that the party or parties involved would prefer to be positive, in the case that the person is a highly-valued customer who purchases many products, participates extensively in the program, etc., or the like) or indicating that an award should not be generated (for instance, in the case that the person is known to purchase and return products very frequently, etc.). As yet another example, a lookup may be performed in connection with the defined funded awards, e.g., to determine whether the retailer, manufacturer, and/or other party has funded one or more specific awards in an attempt to deflect product returns, or the like. In this regard, a rules-based approach for determining whether a return should be provided, and/or how much an award should be, is discussed in greater detail above. It will be appreciated that certain example embodiments may use one or more of these and/or other lookups in order to determine whether a reward should be offered for the product presented for return.

In certain example embodiments, a reason for the return need not necessarily be provided. It nonetheless might be possible to predict why a return is being made based on a customer's particular history (e.g., the customer repeatedly buys products and returns them a few weeks later), intelligence provided by a party about the specific promotion(s) it is running and/or price adjustments it is offering, intelligence provided by a party about the specific promotion(s) a competitor is running and/or price adjustments the competitor is offering, etc. Similarly, a product may be flagged by a retailer, manufacturer, or other authorized party as being subject to a product recall, rebate, etc.; having received “bad PR,” negative reviews, or the like; being replaced or otherwise outmoded by a new model; associated with the release of a competing product from a competitor; etc. It thus may be possible in certain example embodiments to take into account actual or inferred information regarding whether an award should be offered.

If step S506 indicates that no award should be generated, then the process proceeds to step S514, e.g., so that a more conventional product return qualification can be performed. This sub-process is described in greater detail below.

If step S506 indicates that an award should be generated, however, then a suitable award is created in step S508. This award may be delivered in any suitable form or forms and may, for example, take the form of an electronic chit, gift card, voucher, a barcode or QR code printed on paper or embedded in/attached to an email message or accessible from a website (e.g., via a mobile device), etc., e.g., as described above in connection with step S108 in FIG. 1. The award. The amount of the award may be determined based on, for example, the actual or inferred reason why the return is being requested (e.g., as explained above); the perceived value of the customer to the manufacturer, retailer, or other party (e.g., as determined based on the customer's “status” in the loyalty program, etc.); one or more rules defined by the interested party or parties (e.g., the manufacturer, retailer, etc.); and/or the like. As a concrete example, the value of the award offered may be equal to a same vendor type price adjustment. This may help reduce the likelihood of a customer returning a product to a store, only to buy the same product from the same store. As another concrete example, the value of the award offered may be a certain percentage (e.g., 95%, 100%, 115%, etc.) of the difference between the price paid and the price at which a competitor is now offering the same product. This may help reduce the likelihood of a customer returning a product to a store, only to buy the same or like item from a competitor brand.

As still another concrete example, the value of the award offered may be the value of a promotional item now being bundled with the product by the same vendor or a competitor of the vendor. For instance, if a video game system is being bundled with an extra controller, video game, or the like, the amount of the award may be equal to that extra controller, video game, etc. In other cases, the award itself may be that extra controller, video game, etc.

Similar awards may be generated for services associated with product purchases, and vice versa. For instance, the incremental value of a “better” smart device that comes with a one year subscription may be provided. This may help reduce the costs associated with subscription cancellation and product returns, e.g., when the same basic plan is in essence cancelled and re-subscribed to just to get a better electronic device, when a new plan by the same provider is rolled out, when sufficiently close substitutes (e.g., as between cable and satellite television providers, wireless providers, etc.) are made yet more attractive by virtue of pricing and/or other promotions, etc.

It will be appreciated that the determination as to how much value should be offered in an award may be based on whether the product presented for return actually qualifies for return. For instance, a retailer, manufacturer, or other party, might perceive that it has added leverage over customers presenting products that cannot be accepted for return using ordinary rules and thus may offer a lesser value as compared to products presented for return within their respective return windows. In a somewhat related vein, a retailer, manufacturer, or other party, might perceive that it has lesser leverage over customers presenting products that are expensive luxury items, have small markets, are difficult to ship and/or handle (e.g., because of size and/or weight), etc., and thus may offer a greater relative value for an award.

Further details concerning how award values may be calculated in accordance with a rules-based approach are provided below.

Referring once again to FIG. 5, as shown in step S510, the customer may be presented with an opportunity to accept the award in lieu of a return. If the generated award is not accepted, then the process proceeds to step S514, where a more conventional return qualification inquiry may be made, e.g., in connection with applicable return policy terms and conditions. In certain example embodiments, an opportunity may be provided for overrides of denied returns, although this need not necessarily take place.

Although not shown in FIG. 5, if a generated award is not accepted, certain example embodiments may attempt to “sweeten the deal,” e.g., by providing increased value according to a predefined rule. In certain example embodiments, incremental upward adjustments of the same or different amounts may be performed several times until the award is accepted, or until a predefined threshold is reached.

If the customer accepts the award, then the return is denied in step S512 and the customer is presented with the award. The award may, for example, have a unique identifier associated with it (e.g., as indicated above), and the issuance of the award may be stored in the ER database in some embodiments, e.g., to help aid in determining whether a voucher (for example) is valid or whether it is likely associated with fraudulent activity (e.g., an attempted redemption of an already-redeemed voucher, a complete fabrication, serial returns associated with the same basic product as tracked through successive voucher issuances, and/or the like).

It will be appreciated that the FIG. 5 award generation techniques may be provided “on an exception basis.” In other words, a manager or other suitably authorized person might need to approve the request for and/or issuance of an award in certain example embodiments. In certain example embodiments, a customer may forego a chance for a return by accepting an award.

In step S516, a record is created in the ER database. This record may help provide subsequent awards verification (e.g., as described in connection with FIG. 3 above). It additionally or alternatively may in certain example embodiments help with report generation. Reports may be generated concerning, for instance, the products presented for return to help identify products that suffering from a large-scale manufacturing defect, the amount of the awards offered to determine whether the deflection rate is too high or too low suggesting that rules should be adjusted accordingly, etc. The reports may be fed back into the system or otherwise analyzed, e.g., to facilitate the automatic adjustment of awards for one or more purposes. Such purposes may include, for example, meeting a target acceptance number or rate for vouchers in lieu of qualifying returns (e.g., vouchers are accepted at least 1% of the time they are offered, 5% of the they are offered, 10% of the time that they are offered, 25% of the time that they are offered, or some other percentage) for a predefined time period (e.g., weekly, monthly, quarterly, on a fiscal year basis, etc.), the maximization of profits over a predefined period of time (e.g., a week, month, quarter, fiscal year, etc.), to drive potential sales to a particular sales channel that may be the same as or different from the sales channel through which the product was purchased (e.g., an offer may be good for in-store purchases only, online purchases only, etc.), and/or the like. In some embodiments, a machine learning system may be implemented to help adduce information relevant to these and/or other purposes. For instance, a machine learning system may be implemented to help determine the lowest level of awards believed to be acceptable to a would-be returning party, etc.

It thus will be appreciated from the above that certain example embodiments may relate to a computer-implemented method of processing a product presented by a returning party in connection with a return transaction. Information about the product presented in connection with the return transaction may be received. A determination may be made, via at least one processor, that an award is available for the returning party in exchange for the returning party not returning the product, with the award possibly being generatable regardless of whether the product qualifies for return under an applicable return policy. An award amount for the award may be calculated via the at least one processor. The award with the calculated award amount may be presented for the returning party (e.g., to the party directly, to an intermediary party, etc.), in exchange for the returning party giving up the right to return the product under the applicable return policy. The determination that the award should be generated for the returning party and the calculation of the award amount each may be based on a set of one or more rules stored in a non-transitory computer readable storage medium, with the set of rules being electronically applicable to at least some of the received information about the product, e.g., in making the determination and performing the calculation.

Non-transitory computer readable storage media tangibly storing instructions that, when executed by at least one processor of an ER system or the like, may perform these and/or similar methods. For instance, in an example embodiment, a non-transitory computer readable storage medium tangibly storing instructions that, when executed by at least one processor of an ER system or the like, may be provided at least: receive information about a product presented in connection with a return transaction; identify, from a set of one or more rules stored in a non-transitory computer readable storage medium, one or more relevant rules to be applied to at least some of the received information about the product; determine, based at least in part on the one or more identified relevant rules, whether an award is available for the returning party in exchange for the returning party not returning the product, the award being generatable regardless of whether the product qualifies for return under an applicable return policy; and calculate, based at least in part on the one or more identified relevant rules, an award amount for the award in response to a determination that an award should be generated, the award with the calculated award amount being presentable to the returning party in exchange for the returning party giving up the right to return the product under the applicable return policy.

FIG. 6 is a schematic view of a system that may be used to implement the product return deflecting techniques of certain embodiments. FIG. 6 is similar to FIG. 4 in that it includes an ER system 602 comprising an ER database 604 and processing resources 606 (e.g., at least one processor and a memory). It will be appreciated that the processing resources 606 shown in FIG. 6 may be configured to execute instructions tangibly stored on a non-transitory computer readable storage medium that perform functionality according to that shown in and described in connection with FIG. 5, for example.

An awards analysis module 608 may, with the aid of the processing resources 606 and the data recorded in the ER database 604 and/or elsewhere, provide analysis concerning products presented for return, efficacy of the awards offered, suggestions as to whether award amounts should be altered (e.g., based on a comparison of the acceptance/decline rates to a target baseline), etc.

Information regarding funded awards 610 is received into the ER system. The funded awards information 610 may include detailed information concerning different promotions that may be run, e.g., as described in detail above. The programs may be defined as a series of one or more rules 612 to be followed. For instance, the rules may identify products for which awards should be offered. The identification may be provided using any suitable technique. For instance, a retailer, manufacturer, or other party also may specify default rules such as, for example, offer a flat X % in value for all products regardless of whether the products qualify for return, offer a flat $Y in value for all products regardless of whether the products qualify for return, etc.

The amount of value for an award offered may be based on other factors such as, for example, estimated or actual shipping and handling costs, actual or expected profit margin, MSRP, price actually paid, service fees associated with the administration of the awards, etc. For instance, actual or approximate product weights may be known in advance, and tiered award amounts may be structured so as to generally correspond to the expected shipping and handling costs. The savings here might be significant, as shipping and handling charges for a large LCD television, for example, oftentimes can reach $20-$300, and the amounts offered can be below, inside of, overlapping with, or coextensive with, this range. As another example, a dollar or percent value amount may be specified based on tiers of profit margins, e.g., such that products with a profit margin less than $10 are offered awards of a first amount, products with a profit margin between $11 and $100 are offered awards of a second amount that is higher than the first amount, products with a profit margin between $101 and $500 are offered awards of a third amount that is higher than the second amount, etc. It will be appreciated that more or fewer thresholds at these and/or other levels may be provided in various example embodiments, and/or the award amounts may increase, decrease, or vary in some other way, as between the different tiers in different example embodiments. A linear, quadratic, or other function additionally or alternatively may be applied in calculating the value of the award. A calculation could include, for example, ((profit margin+estimated reverse logistics and handling costs)−voucher service fees).

Instead of, or in addition to, default rules such as those described above, more specific rules may be generated for products, potentially down to the individual item level. For instance, one or more UPCs may be provided by a manufacturer to identify one or more corresponding products in its/their entirety/entireties; one UPC and a serial number range may be used to uniquely identify a subset of products produced, etc.; a specific product at a specific store may be identified; etc. Once identifications are made, specific award amounts and/or award types may be specified. The rules-based approach may help take into account products that are known or suspected to be defective but still generally functional, where the overall value to a consumer might be diminished but where the consumer might nonetheless opt to keep the product if compensated with an award generated in accordance with certain embodiments.

The rules-based approach similarly may help take into account promotions, price adjustments, or the like, run by a party or a competitor. For instance, if a store knows that it will be offering a sale, it may identify and/or define a rule specifying that all related products purchased within the last predetermined number of days (e.g., 29 days, or one day short of the normal return period, for example) should be entitled to awards amounting to the price drop, etc. Similarly, if a store knows that it will be, or that a competitor currently is, offering a promotion where a related product or gift card is being distributed, it may define an award of a similar monetary amount, an award in the form of the same or equivalent related product or gift card, etc.

In certain embodiments, a time-value function may be applied to different awards. For example, vouchers may have declining or varied values. To simulate shopping “today,” a retailer, manufacturer, or other party, can make the voucher worth more “today” than “tomorrow.” The rate at which the value decreases may be spelled out for the customer, e.g., on the voucher itself, and it may be stepped, linear, or non-linear in different examples.

As another example of a multi-tiered or variable award amount approach, if a manufacturer who makes electronics products generally wants to provide multiple awards for a given voucher, rules may be specified in this regard. For instance, a manufacturer might generate a single voucher that conveys $100 in value for a same-brand Blu-Ray player but only $20 for any brand printer cartridges. The ability to provide multiple awards for a single voucher may open-up cross-marketing possibilities, expose customers to a manufacturer's different product lines, guide customers to products with high profit margins (e.g., so that the impact of the award does not seem so acute), etc. Information about the customer's prior purchases as retrieved from a conventional loyalty system may, for example, be consulted and help determine other opportunities, e.g., to steer customers towards products they are likely to purchase, towards products they are unlikely to purchase, etc.

Award definitions, rules, and/or the like, may be provided using suitable portals such as, for example, the retailer portal(s) 614 and the manufacturer portal(s) 616 shown in FIG. 6. These portals may be accessible using an electronic device such as a computer over a computer-mediated network such as the Internet. In some cases, a web-based or other user interface may be provided.

Similar to FIG. 4, a store return point and/or online return system 618 may have access to the ER system 602, the conventional loyalty programs/promotions 408, etc.

It thus will be appreciated from the above that certain example embodiments may relate to an ER system that includes, for instance, processing resources including at least one processor and a memory, and an ER database storing entries for sold products. The ER database may be queryable by the processing resources in making product return qualifications. A non-transitory computer readable storage medium may tangibly store third party definable rules, with at least some of the rules potentially specifying when an award should be generated, and/or how much and what kind of value is to be provided with a generated award. The processing resources may be configured to execute instructions in order to at least: receive information about a product presented in connection with a return transaction; identify, from among the third party definable rules stored in the non-transitory computer readable storage medium, one or more relevant rules to be applied to at least some of the received information about the product; determine, based at least in part on the one or more identified relevant rules, whether an award is available for the returning party in exchange for the returning party not returning the product, the award being generatable regardless of whether the product qualifies for return under an applicable return policy; and calculate, based at least in part on the one or more identified relevant rules, an award amount for the award in response to a determination that an award should be generated, the award with the calculated award amount being presentable to the returning party in exchange for the returning party giving up the right to return the product under the applicable return policy.

Example Techniques for Reducing Fraud Associated with Generated Rewards

The techniques described in U.S. Publication Nos. 2011/0016008; 2011/0119142; 2012/0078739; and/or 2012/0123845 may be used to help reduce fraudulent transactions related to vouchers in certain embodiments. The entire contents of each of these publications are hereby incorporated herein by reference. Thus, another advantage of certain example embodiments relates to the ability to link a product's unique identifier with a promotion/voucher to mitigate fraudulent return behavior. For example, if a customer receives and redeems a voucher and then attempts to return the original purchased item, the system may be configured to detect this behavior and alert the store associate that the customer should only be refunded the net amount from the purchase price, less the voucher amount. This may be accomplished by querying the database to determine whether the voucher is valid, and then searching the repository to determine the value of the voucher (e.g., if it is not known from the scanning of a code thereon). Similarly, if the customer attempts to return the originally purchased item without the voucher, the store associate may be alerted to either request the voucher be presented for return or, again, refund only the netted amount.

The same or similar techniques may also be used to determine whether an award can only be redeemed for a certain product, a certain brand of products, etc. For instance, a unique identifier associated with an award may be used to initiate a lookup in the ER database to determine whether there are terms and conditions attached to the specific reward and, if so, to make sure that any such terms and conditions are met before applying the value of the award. In this way, it may be possible to prevent vouchers with multiple possible rewards from being redeemed multiple times unless so authorized by the party that defined the rule(s) under which the award was issued. In the event that a voucher with multiple rewards is redeemed in part, the ER database may be updated accordingly to ensure that that portion of the voucher cannot be reused.

As indicated above, vouchers or other awards may be validated in real-time or substantially in real-time, e.g., for fraud detection purposes. Additionally, or in the alternative, similar lookup techniques may be used to adjust the values of vouchers, e.g., if time-value functions are applied, by taking into account the date of issuance and the date of attempted redemption. The ER database storing the functions and the relevant date(s) may be consulted to aid in this computation.

Certain example embodiments also may attempt to reduce the likelihood of a person trying to “game the system.” For example, a less than scrupulous person might be tempted to present the same product for a possible return transaction multiple times, just to see what awards are available. To help combat this practice, the ER database may track how many times a given product is presented and/or how many awards are generated for a particular product. For instance, a rule may be applied in an effort to limit the number of awards generated, e.g., such that a predefined number of awards are generatable within a predefined time period. An example rule might specify that awards can be generated, provided that a product is presented for a return transaction no more than once, twice, three times, or some other number of times, either on a total product lifetime basis, or within a predefined time period such as a week, month, 90-day period, period during which returns are accepted, etc. If these criteria are not met (e.g., a product is presented for return too many times, e.g., in too of a time period), the system may indicate that an award is not available for that particular product.

As another example of how potentially abusive practice could be curtailed involves varying the award amount and/or type. For instance, a target award amount may be generated, and distribution of individual award amounts may be variably generated around this target. The distribution could be random, uniform, normal, etc., and it may be generated by the ER system based on a random number generator (e.g., so as to generate a random distribution), probabilistically (e.g., so as to approximate a normal or other mathematically definable distribution), and/or the like. The extent of the distribution may be set by an authorized rule creator or determined automatically, e.g., based on the target award amount, information about the profit margin, etc. For example, the maximum and minimum points in a distribution may be set as plus/minus some user-defined percentage and/or dollar value around the target. Alternatively, or in addition, the award types may vary, e.g., as between vouchers good for in-store use, vouchers good for online use, gift cards, promotional giveaway items, etc. In some cases, the award amount may be randomized and the reward type may also be randomized. The ER system may track the awards generated for accounting purposes, to help ensure that uniform, normal, and/or other distributions are approximated over time, etc.

In certain example embodiments, a cutoff point for possible voucher values may be defined over a period of time and/or over a sliding time window. For example, higher values may be generated initially, e.g., to possibly help curb more immediate cases of buyer's remorse, to reflect the likelihood that people who kept a product for longer likely enjoyed at least some of their benefits, etc. Maximum award amounts and/or types may be generated for cutoff points within a return window, for example, at the one-week, two-week, one-month, two-month, 90-day, and/or other marks. The values may be implemented in a stepped manner, in accordance with a mathematical formula that is linear or non-linear, etc. See, for example, U.S. Publication No. 2011/0016008, which describes (among other things) tailoring a return type to a discrete time period, and which is hereby incorporated by reference herein in its entirety.

Furthermore, in certain example embodiments, and as alluded to above, a customer's particular history (e.g., indicating that the customer repeatedly buys products and returns them a few weeks later, etc.), may be taken into account in order to help curb potentially abusive practices. For example, the ER system may perform a lookup against “loyalty score” and/or other related data maintained by a retailer, e-tailer, manufacturer, and/or other party. In some cases, the ER system may maintain this information itself. However, in other cases, it may be advantageous to insulate the ER database provider from such information, e.g., so that the ER database in effect tracks products, not people. Information identifying an individual may be received at a transaction location, and this information may include, for example, a loyalty number or other alphanumeric identifier of the person, information from a driver's license (e.g., driver's license number, state, and/or the like), credit card number, etc. This information may be hashed and compared against the information about the customer maintained by the ER system and/or the loyalty program system. Data concerning the total number of returns attempted and/or completed, total reward amounts generated, etc., over a predefined time period (e.g., lifetime, last month, quarter, etc.), may be calculated. If it appears that the customer is a person who has been flagged as someone who repeatedly returns items (e.g., more than X items in Y days), the award amount may have a lessened maximum value, an award may not be made available at all, etc. It is noted that the system may enable these and/or other types of flagged customers to “redeem themselves” over time, e.g., by purchasing more products, initiating fewer returns, etc., and rules may be defined to take this into account. On the other hand, if the person has a high loyalty score (e.g., few returns, many purchases from a retailer and/or of a certain brand, etc.), a comparatively higher value may be provided for an award. Of course, for loyal customers, lower awards may be accepted because of they are willing to “put up” with more, and rules may be defined to take this into account.

The ER database may be an ER database as described in, for example, U.S. Pat. Nos. 5,978,774; 6,018,719; and 6,085,172, the entire contents of which are hereby incorporated herein by reference.

It will be appreciated that the features, aspects, advantages, and embodiments described herein may be combined in various combinations and sub-combinations to achieve yet further example embodiments.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A computer-implemented method of processing a product presented by a returning party in connection with a return transaction, the method comprising:
receiving information about the product presented in connection with the return transaction;
determining, via at least one processor, that an award is available for the returning party in exchange for the returning party not returning the product, the award being generatable regardless of whether the product qualifies for return under an applicable return policy;
calculating, via the at least one processor, an award amount for the award; and
presenting the award with the calculated award amount for the returning party, in exchange for the returning party giving up the right to return the product under the applicable return policy,
wherein the determination that the award should be generated for the returning party and the calculation of the award amount each are based on a set of one or more rules stored in a non-transitory computer readable storage medium, the set of rules being electronically applied to at least some of the received information about the product, in making the determination and performing the calculation.

2. The method of claim 1, wherein the product does not qualify for return under the applicable return policy.

3. The method of claim 1, wherein the received information about the product includes a unique identifier of the product.

4. The method of claim 1, wherein the information is electronically received from a remote retailer location.

5. The method of claim 1, wherein the information is electronically received over a network from a remote online return processing system.

6. The method of claim 1, wherein the presented award is a printed voucher.

7. The method of claim 1, wherein the award amount is calculated as a function of actual or expected shipping and handling costs that would be incurred if the product presented in connection with the return transaction were actually returned.

8. The method of claim 1, wherein at least one rule is specified to take into account a price adjustment that has been, is being, and/or will be offered.

9. The method of claim 8, wherein the award amount is calculated as a function of the price adjustment.

10. The method of claim 9, wherein the award amount is at least equal to the price adjustment.

11. The method of claim 8, wherein the price adjustment is a price adjustment that has been, is being, and/or will be offered by a competitor of the party specifying the rule.

12. The method of claim 1, wherein at least one rule is specified to take into account a non-monetary promotion that has been, is being, and/or will be offered.

13. The method of claim 12, wherein the award amount is calculated as a function of the non-monetary promotion.

14. The method of claim 13, wherein the award amount is a monetary value that is at least equal to the actual or perceived value of the non-monetary promotion.

15. The method of claim 12, wherein the presented award is the same as or equivalent to the non-monetary promotion.

16. The method of claim 1, further comprising receiving information indicating why the product is being presented in connection with the return transaction.

17. The method of claim 16, wherein the set of rules is electronically applied, via the at least one processor, to at least some of the received information indicating why the product is being presented in connection with the return transaction, in making the determination and performing the calculation.

18. The method of claim 16, wherein the received information indicating why the product is being presented in connection with the return transaction is determined inferentially, taking into account at least the received information about the product presented in connection with the return transaction.

19. The method of claim 1, further comprising:
assigning a unique identifier to a presented award; and
in response to the presented award being accepted by the returning party, registering the presented award, together with its unique identifier, with an electronic registration (ER) database of an ER system.

20. The method of claim 1, wherein the award is presented to the returning party by an agent of a retailer from which the information about the product is received.

21. The method of claim 1, wherein the product is a service.

22. The method of claim 21, wherein the return transaction involves cancellation of the service.

23. The method of claim 1, wherein the product is a post-paid product associated with a service being cancelled.

24. The method of claim 1, further comprising receiving information about the returning party.

25. The method of claim 24, wherein the information includes a loyalty score associated with the returning party.

26. The method of claim 24, wherein the information about the returning party is taken into account in making the determination and/or in performing the calculation.

27. A non-transitory computer readable storage medium tangibly storing instructions that, when executed by at least one processor of an electronic registration (ER) system, at least:
receive information about a product presented in connection with a return transaction;
identify, from a set of one or more rules stored in a non-transitory computer readable storage medium, one or more relevant rules to be applied to at least some of the received information about the product;
determine, based at least in part on the one or more identified relevant rules, whether an award is available for the returning party in exchange for the returning party not returning the product, the award being generatable regardless of whether the product qualifies for return under an applicable return policy; and
calculate, based at least in part on the one or more identified relevant rules, an award amount for the award in response to a determination that an award should be generated, the award with the calculated award amount being presentable to the returning party in exchange for the returning party giving up the right to return the product under the applicable return policy.

28. The non-transitory computer readable storage medium of claim 27, wherein the product qualifies for return under the applicable return policy.

29. The non-transitory computer readable storage medium of claim 27, wherein the information is electronically received from a retailer, e-tailer, or call center location, remote from the ER system, on behalf of a customer.

30. The non-transitory computer readable storage medium of claim 27, wherein further instructions are provided to at least:
receive information indicating why the product is being presented in connection with the return transaction; and
identify one or more relevant rules to be applied to at least some of the received information indicating why the product is being presented in connection with the return transaction.

31. The non-transitory computer readable storage medium of claim 27, wherein further instructions are provided to at least:
receive information about the returning party; and
take into account the information about the returning party in determining whether the award is to be offered for the returning entity and/or the value of the award.

32. An electronic registration (ER) system, comprising:
processing resources including at least one processor and a memory;
an ER database storing entries for sold products, the ER database being queryable by the processing resources in making product return qualifications; and
a non-transitory computer readable storage medium tangibly storing third party definable rules, at least some of the rules specifying when an award should be generated, and/or how much and what kind of value is to be provided with a generated award;
wherein the processing resources are configured to execute instructions in order to at least:
receive information about a product presented in connection with a return transaction;
identify, from among the third party definable rules stored in the non-transitory computer readable storage medium, one or more relevant rules to be applied to at least some of the received information about the product;
determine, based at least in part on the one or more identified relevant rules, whether an award is available for the returning party in exchange for the returning party not returning the product, the award being generatable regardless of whether the product qualifies for return under an applicable return policy; and
calculate, based at least in part on the one or more identified relevant rules, an award amount for the award in response to a determination that an award should be generated, the award with the calculated award amount being presentable to the returning party in exchange for the returning party giving up the right to return the product under the applicable return policy.

33. The ER system of claim 32, wherein the rules are definable to indicate whether an award should take the form of monetary or non-monetary value; be offered to only a specified class of customers; and/or be limited with respect to a certain product or product type.

34. The ER system of claim 32, wherein the award amount is calculated as a function of both shipping and handling costs that would be incurred if the product presented in connection with the return transaction were actually returned, and a service fee charged in creating the award.

35. The ER system of claim 32, wherein the rules are definable to take into account a reason as to why the product is being presented in connection with the return transaction and/or an identity of the person who purchased the product.
